(19) United States
(12) Patent Application Publication
(10) Pub. No.: US 2003/0156732 A1
(43) Pub. Date: Aug. 21, 2003

(54) Speaker and method of manufacturing the same

(75) Inventor: Ha-Ryong Hong, Suwon-si (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/132,164

(22) Filed: Apr. 26, 2002

(30) Foreign Application Priority Data
Feb. 15, 2002 (KR) 2002-8137

(51) Int. Cl. H04R 1/00; H04R 9/06; H04R 11/02

(52) U.S. Cl. 381/409; 381/403

(57) ABSTRACT

A speaker and a method of manufacturing the speaker are provided. The speaker includes a terminal board attached to a side surface of the frame and connected to the electric signals, a dust cap for preventing the inflow of foreign matters into a gap of the magnetic circuitry, an edge formed on the circumference of the cone paper, and a gasket acting to prevent the resonance of the frame and a cover with metal parts, in fixing the frame and the cover of the speaker, and to prevent the delamination and separation of the edge from the cone paper by the vibration of the cone paper. The damper is maximally enlarged in its size, thereby maximizing amplitude of output sound via the damper and attenuating a low band factor. The damper is connected to the upper surface of the voice coil and the upper surface of the frame. Thereby, in case of a speaker with a size of less than Φ45 mm, the minimum resonance frequency can be attenuated to less than 300 Hz. The speaker of the present invention may be applied to various electric appliances and satisfy the trend of compactness and slimness.

### BACKGROUND OF THE INVENTION

1. Field of the Invention

The present invention relates to a speaker and a method of manufacturing such a speaker, and more particularly to a slim and small speaker, in which a damper is installed above gold, thereby maximizing amplitude of output sound via the damper, attenuating a minimum resonance frequency, and reinforcing low band, and a method of manufacturing the speaker.

2. Description of the Related Art

As well known to those skilled in the art, a Neodymium (Nd) magnet, i.e., one of rare earth magnets, has a very great magnetic energy. The Nd magnet is usually used in modern products with a slim and small structure. Therefore, the Nd magnet type speakers are integrally installed on notebook computers, small-sized personal computers, slim computers or LCD monitors, etc.

Generally, speakers are divided into various types for high-pitched tones, middle and low-pitched tones, and full-ranged tones. A speaker for high-pitched tones is referred to as a “Tweeter”, which outputs short wavelengths. A speaker for middle-pitched tones is referred to as a “Midranger” or a “Squaker”. A speaker for low-pitched tones is referred to as a “Woofer”, which output long wavelengths. Further, a speaker for full-ranged tones is referred to as a “Full range”, which can reproduce sound of the entire pitch band. In order to reproduce sound of high-pitched tones, a sub-cone, a copper cap, and so on are employed.

FIG. 1 is a cross-sectional view of a conventional Nd magnet type speaker.

With reference to FIG. 1, a frame 1 determines a size and a shape of the speaker. The frame 1 supports a vibration gauge including a cone paper 3, a damper 9, a voice coil 4, gold wires 10, an edge 2, a gasket 12, a dust cap 5, and so on, and magnetic circuitry including an upper plate 6, a magnet 7, a yoke 8, and so on. The frame 1 is stepwisely formed. That is, the frame 1 includes a first step 1-1, to which the edge 2 is bonded, a second step 1-2, which is stepwisely connected to the first step 1-1, and a third step 1-3, to which the damper 9 is connected.

With the conventional structure of the speaker, in case an outer diameter of the frame 1 is less than 100 mm, since there is a limit to the amplitude of the damper 9, it is impossible to reproduce sound of low band and to attenuate the minimum resonance frequency.

The reproduction of sound of low band is determined by the amplitude of the damper and the amplitude of the cone paper. As shown in FIG. 1, the cone-shaped speaker with a size of less than Φ45 mm cannot attenuate the minimum resonance frequency (fo) to less than 300 Hz. Therefore, in order to attenuate the frequency, a butterfly damper may be used. Alternatively, no damper is used. However, since the butterfly damper is very expensive, it cannot be applied to general speakers of low price. Further, without the damper, power output more than a designated amount cannot be achieved.

### SUMMARY OF THE INVENTION

Therefore, the present invention has been made in view of the above problems, and it is an object of the present invention to provide a speaker, in which a damper is installed above gold wires, thereby maximizing amplitude of the damper, attenuating a minimum resonance frequency, and reinforcing low band, and a method of manufacturing the speaker.

In accordance with one aspect of the present invention, the above and other objects can be accomplished by the provision of a speaker comprising a vibration gauge comprising a cone paper, a damper, a voice coil, and gold wires, and magnetic circuitry comprising an upper plate, a magnet, and a yoke. The damper is installed above the gold wires and enlarged in its size, thereby magnifying the amplitude of output sound and reinforcing a low band factor.

In accordance with another aspect of the present invention, there is provided a speaker comprising a frame for fixing a vibration gauge and magnetic circuitry, a size and a shape of the speaker being determined by the frame, a yoke formed on the lower surface of the frame and acting as a passage for line of magnetic force, the line of magnetic force smoothly flowing via the yoke, a magnet mounted on the upper surface of the yoke and continuously supplying a direct current magnetic flux to the magnetic circuitry, an upper plate installed on the upper surface of the magnet and forming the magnetic circuitry, gold wires for transmitting electric signals to a voice coil, a voice coil generating a vibratory force by repulsive energy of electric signals transmitted through the gold wires, a damper for quenching vibration or amplitude, the damper formed above the gold wires connected to the voice coil, and a cone paper for reproducing sound source by generating vibration to the speaker.

Preferably, the speaker may further comprise a terminal board attached to a side surface of the frame and connected to the electric signals supplied from a audio signal amplification circuit, a dust cap for preventing the inflow of foreign matters into a gap of the magnetic circuitry, an edge formed on the circumference of the cone paper and acting as a fixture for helping the cone paper to smoothly vibrate and to return to its original position, and a gasket acting to prevent the resonance of the frame and a cover with metal parts, in fixing the frame and the cover of the speaker and to prevent the delamination and separation of the edge from the cone paper by the vibration of the cone paper.

Further, preferably, the speaker may further comprise a ring-shaped cover formed between the upper surface of the yoke and the voice coil, in order to prevent the inflow of foreign matters into the gap of the yoke due to the arrangement of the damper above the gold wires.

The damper is connected to the upper surface of the voice coil and the upper surface of the frame.

In accordance with yet another aspect of the present invention, there is provided a method of manufacturing a speaker, the method comprising the steps of i) preparing a yoke and a magnet and attaching them together, ii) pressing a terminal board on a frame, iii) pressing an upper plate on the magnet, iv) attaching magnetic circuitry comprising the yoke, the magnet and the upper plate to the frame, (v) inserting and fixing a voice coil into a gap between the yoke and the upper plate, (vi) connecting gold wires to the voice coil, (vii) mounting a damper above the gold wires and bonding the damper to the upper surfaces of the frame and the voice coil, (viii) attaching a dust cap to the upper surface of the voice coil and bonding a cone paper above the bonded damper, and (ix) bonding an edge and a gasket to the circumference of the cone paper, thereby completing the manufacture of the speaker.

Preferably, the speaker manufacturing method may further comprise the steps of: (x) testing the manufactured speaker by a visual inspection or with test jigs, and (xi) testing the manufactured speaker by a test display device for testing output characteristic of the speaker by measuring the ratio of impedance to frequency.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view of a conventional Nd magnet type speaker;

FIG. 2 is a cross-sectional view of a low-band reinforced slim Nd magnet type speaker in accordance with the present invention;

FIG. 3 is a flow chart showing a method of manufacturing the speaker in accordance with the present invention; and

FIG. 4 is a frequency response graph showing output characteristic of the speaker of the present invention using a display device.

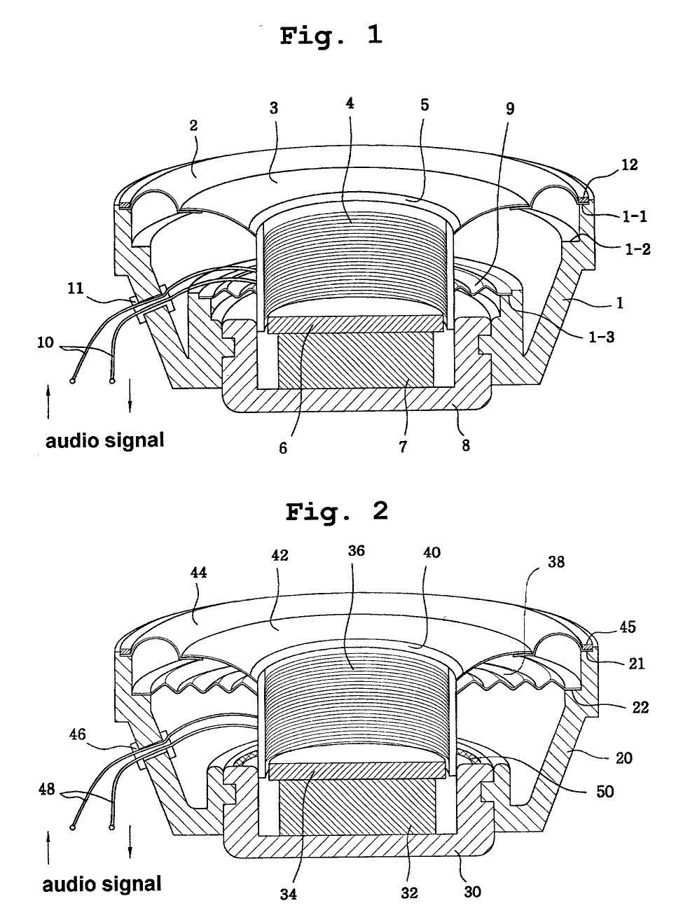

### DESCRIPTION OF THE PREFERRED EMBODIMENTS

FIG. 2 is a cross-sectional view of a slim low-band reinforced Nd magnet type speaker in accordance with the present invention.

As described above, a frame 20 determines a size and a shape of the speaker and fixes a vibration gauge including a cone paper 42, a damper 38, a voice coil 36, gold wires 48, and so on, and magnetic circuitry including an upper plate 34, a magnet 32, a yoke 30, and so on. The frame 20 is made of a cold-rolled steel plate, an ABS resin, or an aluminum (Al) plate.

The yoke 30 (also, referred to as a “bottom plate”) is formed on the lower surface of the frame 20. The yoke acts as a passage for line of magnetic force. The line of magnetic force may smoothly flow via the yoke 30. The yoke 30 is generally made of pure steel.

The magnet 32 is an essential component of the magnet circuitry and uses a permanent magnet. The magnet 32 is formed on the yoke 30. The magnet 32 induces a vertical motion of the voice coil 36 by Fleming's left-hand law. The magnet 32 continuously supplies a direct current (DC) magnetic flux to the magnetic circuitry.

The upper plate 34 is formed on the upper surface of the magnet 32.

As described above, the yoke 30, the magnet 32, and the upper plate 34 constitute the magnetic circuitry.

A terminal board 46 is attached to a side surface of the frame 20 at a designated area. The terminal board 46 comprises a plurality of terminals for supplying electrical signals impressed from an audio signal amplification circuit to the speaker.

The gold wires 48 connect the terminal board 46 to the voice coil 36. Thereby, the gold wires 48 act to transmit the electrical signals inputted via plural terminals of the terminal board 46 to the voice coil 36.

The voice coil 36 receives electrical signals from an amp output station via the gold wires 48. Then, the voice coil 36 generates vibratory force by repulsive energy of the input electrical signals. The voice coil 36 is produced by coating a conductive wire made of copper(Cu) or aluminum(Al) with an insulating layer and an adhesive layer and winding the coated wire on a bobbin made of paper or aluminum sheet.

The damper 38 is installed above the gold wires 48. The damper 48 acts to attenuate the vibration and/or the amplitude. The damper 48 is a leading component of the vibration gauge of the speaker. The damper 38 supports a connection part between the cone paper 42 and the voice coil 36 and occupies mostly a stiffness of the speaker.

The cone paper 42, i.e., a vibrating table, serves to reproduce a sound source by generating the vibration to the speaker. Herein, the term “cone paper” originates from its conical shape. The cone paper 42 receives the vibration of the voice coil 36 and generates acoustic waves by compressive strain of air. Further, the cone paper 42 affects the reproduction tone quality of the speaker. The reproduction tone quality and the reproduction tone color are affected by the material of the cone paper 42. That is, the reproduction frequency characteristic is changed by the size, the weight, and the cross-sectional shape of the cone paper 42.

A dust cap 40 serves to prevent the inflow of foreign matters into a gag of the magnetic circuitry and to change frequency characteristic at high band of the speaker according to its material, weight and cross-sectional shape. Particularly, a trumpet-shaped duct cap is referred to as a “double cone”. The dust cap 40 is made of paper, mylar or cloth.

The speaker further comprises an edge 44 and a gasket 45. The edge 44 is formed on the circumference of the cone paper 42 and acts as a fixture for helping the cone paper body to smoothly vibrate. Further, the edge 44 is the fixture for helping the cone paper to return to its original position. The gasket 45 is usually used in a speaker with a larger diameter. The gasket 45 acts to prevent the resonance of the frame 20 and a cover with metal parts, in fixing the frame 20 and the cover of the speaker. Further, the gasket 45 acts to prevent the delamination and separation of the edge 44 from the cone paper 42 by the vibration of the cone paper 42.

In accordance with the present invention, the damper 38 serves to damp the mechanical vibration. For example, the damper 38 is a rubber member supporting a cantilever of a cartridge. The performance of the damper 38 directly affects a tracing capacity or a cross talk. The damper 38 further serves to maintain the voice coil 36 of the speaker at the center of the gap.

The damper 38 is formed below the cone paper 42 in the frame 10. One end of the damper 38 is attached to the voice coil 36 and the other end of the damper 38 is attached to the frame 20. The damper 38 fulfils the vertical linear motion of the voice coil 36. Further, the damper 38 properly damps the vertical linear motion of the voice coil 36. That is, the damper 38 accomplishes a center-maintaining function to operate the voice coil 36 exactly on the gap of the magnetic circuitry, rather than a damping function. Since the damper 38 controls the amplitude, the damper 38 can modulate the minimum resonance frequency (fo) and the power output. By fixing the voice coil 36 to the center of the gap of the magnetic circuitry, the vertical linear motion of the vibration gauge is induced, thereby preventing the distortion of sound. The damper 38 blocks the inflow of foreign matters into the gap and supplies restoring force to the vertical linear motion.

The damper 38 of the present invention is made by impregnating cloth such as cotton and synthetic fiber with thermoplastic resin such as phenol. Then, the damper 38 is processed in a corrugated shape by compressing it with a thermal press. The minimum resonance frequency (fo) of the speaker unit can be adjusted by the impregnation amount of phenol. The dampers may be manufactured in various types, i.e., a corrugated damper with a circular shape, an oval shape, or a rectangular shape, or a butterfly damper. The butterfly damper is manufactured by cutting a thin plate in a designated shape, which can fulfill the linear motion.

Compared to the conventional case, the damper 38 of the present invention is maximally enlarged. Thereby, the minimum resonance frequency (fo) and low band may be reinforced. That is, the damper 38 of the present invention can reinforce low sound and low band even in a small-sized speaker by maximizing amplitude of the power output.

As shown in FIG. 2, the frame 20 is stepwisely formed. An end of the damper 38 is bonded to a second step 22 of the frame 20 and the other end of the damper 38 is connected to the upper surface of the voice coil 36. Thereby, compared to the conventional damper of the speaker, the damper 38 is enlarged in its size. Therefore, low band and low sound of the small-sized speaker can be reinforced by this enlarged damper 38. The edge 44 is connected to the cone paper 42 at a first step 21 of the frame 20.

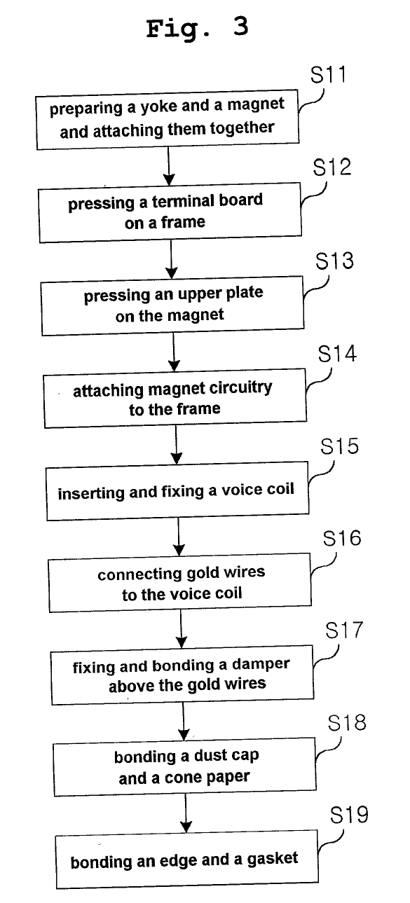

A method for manufacturing the low-band reinforced speaker of the present invention is described below with reference to FIG. 3.

FIG. 3 is a flow chart showing the method of manufacturing the speaker in accordance with the present invention.

First, the yoke 30 and the magnet 32 are prepared and attached together (S11). The terminal board 46 is pressed on the frame 20 (S12). The upper plate 34 is pressed on the magnet 32 (S13).

In S14, the magnetic circuitry including the yoke 30, the magnet 32 and the upper plate 34 is attached to the frame 20.

The voice coil 36 is inserted and fixed into a gap between the yoke 30 and the upper plate 34 (S15). Then, the gold wires 48 are connected to the voice coil 36 (S16).

The damper 38 is mounted above the gold wires 48 and bonded to the upper surfaces of the frame 20 and the voice coil 36. One end of the damper 38 is bonded to the upper surface of the voice coil 36 and the other end of the damper 38 is bonded to the second step 22 of the frame 20 (S17).

The dust cap 40 is installed and fixed on the upper surface of the voice coil 36. The cone paper 42 is bonded to the fixed damper 38 (S18). The edge 44 and the gasket 45 are bonded to the circumference of the cone paper 42 (S19). Thereby, the manufacture of the speaker of the present invention is completed.

The manufactured speaker of the present invention is visually inspected, or the output characteristic of the manufactured speaker is tested. That is, the manufactured speaker is tested by a visual inspection or by testing jigs. Further, the manufactured speaker is again tested by a test display device for testing the output characteristic of the speaker by measuring impedance compared to frequency.

Conventionally, the damper is connected to the third step of the frame and the lower surface of the voice coil. That is, the conventional damper is installed below the gold wires. However, the damper 38 of the present invention is connected to the second step 22 and the upper surface of the voice coil 36 above the gold wires 48. Therefore, the damper 38 is maximally enlarged in its size, thereby maximizing the amplitude of the power output.

Further, the speaker of the present invention includes a ring-shaped cover 50 formed between the upper surface of the yoke 30 and the voice coil 36, in order to prevent the inflow of foreign matters into the gap of the yoke 30 due to the arrangement of the damper 38 above the gold wires 48.

By arranging the damper 38 above the gold wires 48, the upper surface of an inner portion of the frame 20 of the present invention is coplanarly coupled with the upper surface of the yoke 30.

Preferably, the present invention is applied to a slim speaker, which has an outer diameter of less than 80 mm and a thickness of less than 60 mm.

Accordingly, the low-band reinforced slim speaker in accordance with the present invention is integrally installed on notebook computers, small-sized personal computers, slim computers or LCD monitors, etc., thereby satisfying the trend of compactness and slimness.

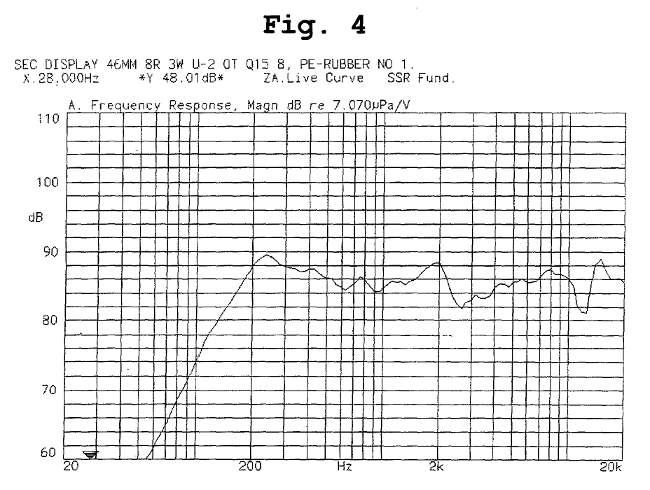

FIG. 4 is a frequency response graph showing output characteristic of the speaker of the present invention using a display device.

The impedance of the speaker is 8Ω, and a minimum resonance frequency (fo), i.e., a response frequency is 250±50 Hz. The power output of the speaker is 3.0 to 5.0 W. As shown in FIG. 4, the speaker of the present invention outputs sound of about 80 to 90 dB in a range of more than approximately 200 Hz in an audio frequency range of 20 Hz to 20 KHz. Therefore, with the present invention, a speaker with a size of less than Φ45 mm can attenuate the minimum resonance frequency (fo) to less than 300 Hz.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A speaker comprising:
a vibration gauge comprising a cone paper, a damper, a voice coil, and gold wires; and
magnetic circuitry comprising an upper plate, a magnet, and a yoke,
wherein said damper is installed above said gold wires and enlarged in its size, thereby magnifying the amplitude of output sound and reinforcing a low band factor.

2. A speaker comprising:
a frame for fixing a vibration gauge and magnetic circuitry, a size and a shape of the speaker being determined by said frame;
a yoke formed on the lower surface of said frame and acting as a passage for lines of magnetic force, the lines of magnetic force smoothly flowing via said yoke;
a magnet mounted on the upper surface of said yoke and continuously supplying a direct current magnetic flux to said magnetic circuitry;
an upper plate installed on the upper surface of said magnet and forming said magnetic circuitry;
gold wires for transmitting electric signals to a voice coil;
a voice coil generating a vibratory force by repulsive energy of electric signals transmitted through said gold wires;
a damper for quenching vibration or amplitude, said damper formed above said gold wires connected to said voice coil; and
a cone paper for reproducing sound source by generating vibration to said speaker.

3. The speaker as set forth in claim 2, further comprising:
a terminal board attached to a side surface of said frame and connected to the electric signals supplied from a audio signal amplification circuit;
a dust cap for preventing the inflow of foreign matters into a gap of said magnetic circuitry;
an edge formed on the circumference of said cone paper and acting as a fixture for helping said cone paper to smoothly vibrate and to return to its original position; and
a gasket acting to prevent the resonance of said frame and a cover with metal parts, in fixing said frame and said cover of the speaker, and to prevent the delamination and separation of said edge from the cone paper by the vibration of said cone paper.

4. The speaker as set forth in claim 2, wherein said damper is connected to the upper surface of said voice coil and the upper surface of the frame.

5. The speaker as set forth in claim 2, further comprising a ring-shaped cover formed between the upper surface of said yoke and said voice coil, in order to prevent the inflow of foreign matters into the gap of said yoke due to the arrangement of said damper above said gold wires.

6. The speaker as set forth in claim 2, wherein its impedance is 8Ω, a minimum resonance frequency (fo), i.e., a response frequency is 250±50 Hz, and power output is 3.0 to 5.0 W, and which outputs sound of about 80 to 90 dB in a range of more than approximately 200 Hz in an audio frequency range of 20 Hz to 20 KHz.

7. A method of manufacturing a speaker, said method comprising the steps of:
i) preparing a yoke and a magnet and attaching them together;
ii) pressing a terminal board on a frame;
iii) pressing an upper plate on said magnet;
iv) attaching magnetic circuitry comprising said yoke, said magnet and said upper plate to said frame;
(v) inserting and fixing a voice coil into a gap between said yoke and said upper plate;
(vi) connecting gold wires to said voice coil;
(vii) mounting a damper above said gold wires and bonding said damper to the upper surfaces of said frame and said voice coil;
(viii) attaching a dust cap to the upper surface of said voice coil and bonding a cone paper above said bonded damper; and
(ix) bonding an edge and a gasket to the circumference of said cone paper, thereby completing the manufacture of the speaker.

8. The speaker manufacturing method as set forth in claim 7, further comprising the steps of:
(x) testing said manufactured speaker by a visual inspection or with test jigs; and
(xi) testing said manufactured speaker by a test display device for testing output characteristics of the speaker by measuring impedance to frequency.

9. The speaker manufacturing method as set forth in claim 7, wherein its impedance is 8Ω, a minimum resonance frequency (fo), i.e., a response frequency is 250±50 Hz, and power output is 3.0 to 5.0 W, and which outputs sound of about 80 to 90 dB in a range of more than approximately 200 Hz in an audio frequency range of 20 Hz to 20 KHz.

10. A speaker manufactured by the method in claim 7.

11. A speaker manufactured by the method in claim 8.

12. A speaker manufactured by the method in claim 9.
